(19) United States
(12) Patent Application Publication
(10) Pub. No.: US 2014/0344269 A1
(43) Pub. Date: Nov. 20, 2014

(54) Semantic Naming Model

(71) Applicant: Convida Wireless LLC, Wilmington, DE (US)

(72) Inventors: Lijun Dong, San Diego, CA (US); Chonggang Wang, Princeton, NJ (US)

(21) Appl. No.: 14/279,965

(22) Filed: May 16, 2014

Related U.S. Application Data
(60) Provisional application No. 61/823,976, filed on May 16, 2013.

(51) Int. Cl. G06F 17/30

(52) U.S. Cl. CPC G06F 17/30424
USPC 707/736; 707/802

(57) ABSTRACT

Semantics may be embedded in the name of sensory data. In an embodiment, an identification of sensory data is created based on attributes that include at least one of time, location, or type.

### CROSS-REFERENCE TO RELATED APPLICATIONS

This application claims the benefit of U.S. Provisional Patent Application No. 61/823,976, filed on May 16, 2013, entitled “SEMANTIC MODEL AND NAMING FOR INTERNET OF THINGS SENSORY DATA,” the contents of which are hereby incorporated by reference herein.

### BACKGROUND

The rapid increase in the number of network-enabled devices and sensors deployed in physical environments is changing communication networks. It is predicted that within the next decade billions of devices will generate a myriad of real world data for many applications and services by service providers in a variety of areas such as smart grids, smart homes, e-health, automotive, transport, logistics, and environmental monitoring. The related technologies and solutions that enable integration of real world data and services into the current information networking technologies are often described under the umbrella term of the Internet of things (IoT). Because of the large amount of data created by devices there is a need for an efficient way to identify and query this data.

### SUMMARY

A semantic model is presented for data which captures major attributes of the data (time, location, type, and value), while providing a linkage to other descriptive metadata of the data. Procedures for data name publishing, data aggregation, and data query are also described.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates sensory data attributes;

FIG. 2 illustrates sensor locations on a map;

FIG. 3 illustrates a construction for embedded semantic naming;

FIG. 4 illustrates another construction for embedded semantic naming;

FIG. 5 illustrates a method for embedded semantic naming;

FIG. 6 illustrates a sensory data retrieval flow;

FIG. 7 illustrates a sensory data query flow;

FIG. 8 illustrates architecture of sensory data publishing, sensing, and querying;

FIG. 9 illustrates a sensory data query flow;

FIG. 10A is a system diagram of an example machine-to-machine (M2M) or Internet of Things (IoT) communication system in which one or more disclosed embodiments may be implemented;

FIG. 10B is a system diagram of an example architecture that may be used within the M2M/IoT communications system illustrated in FIG. 10A;

FIG. 10C is a system diagram of an example M2M/IoT terminal or gateway device that may be used within the communications system illustrated in FIG. 10A; and

FIG. 10D is a block diagram of an example computing system in which aspects of the communication system of FIG. 10A may be embodied.

### DETAILED DESCRIPTION OF ILLUSTRATIVE EMBODIMENTS

Network-enabled sensor devices enable capturing and communicating observation and measurement data collected from physical environments. A sensor as discussed herein may be defined as a device that detects or measures a physical property and records, indicates, or otherwise responds to it. For example, sensors may detect light, motion, temperature, magnetic fields, gravity, humidity, moisture, vibration, pressure, electrical fields, sound, and other aspects of an environment. Sensory data may include observations of an environment or measurement data, as well as time, location, and other descriptive attributes to help make the data meaningful. For example, a temperature value of 15 degrees may be more meaningful when it is described with spatial (e.g. Guildford city center), temporal (e.g. 8:15 AM GMT, 21-03-2013), and unit (e.g. Celsius) attributes. The sensory data may also include other detailed metadata that describes quality or device related attributes (e.g. precision, accuracy).

A significant number of existing network-enabled sensor devices and sensor networks are resource constrained (i.e., often have limited power, bandwidth, memory, and processing resources), so sensors should also support in-network data processing to aggregate or summarize the data to reduce communication overload. If a semantic annotation is considered to be performed on a more powerful intermediary node (e.g., a gateway node) there may still be a vast amount of streaming data where the size of the metadata is significantly larger than the original data. In such cases, a balance between expressiveness, level of details, and size of metadata descriptions should be considered. Semantic descriptions may provide machine-interpretable and interoperable data descriptions for sensory data. The semantic models, described herein, for Internet of things (IoT) sensory data may express major attributes of the sensory data while still being lightweight. For example, the semantic naming model disclosed herein allows for some primary attributes of sensory data, while the number of attributes is limited to reduce the amount of information that needs to be transmitted across networks.

Current Internet of things (IoT) data naming follows the traditional content naming scheme, which is a uniform resource identifier (URI) or a uniform resource locator (URL) based scheme (e.g., ETSI machine-to-machine (M2M) Resource Identifier). The sensory data from sensors is named by the gateway (derived from the resource structure where the data is stored in the gateway), which means the original source of the data does not determine the name of the data. There is lack of a naming scheme for sensory data in providing efficient end-to-end solutions for publishing and consumption of sensory data and providing discovery mechanisms to enable a distributed sensory data query.

Disclosed herein is a naming scheme that has embedded semantics (embedded semantic naming) that captures major attributes of sensory data (e.g., time, location, type, and value), while providing linkage to other descriptive metadata of the sensory data. The semantic model is a naming scheme for sensory data, which can identify the sensory data, as well as incorporate additional semantic information in the name. The naming scheme involves the data source (i.e., a sensor) in naming the sensed data, but also balances between the overhead and complexity added to a sensor and the expressiveness of the name. The naming scheme facilitates the distributed sensory data publishing and discovery by providing additional semantic information of the data in the name. The naming scheme may enable data aggregation, which may be performed automatically without any additional information to instruct how to perform the aggregation. Also disclosed is a format of fields in the name, which may further strengthen the naming scheme. Procedures for publishing of the name of the sensory data, aggregation of the sensory data, and querying of the sensory data are also disclosed.

As shown in Table 1, a model for sensory data (or in general IoT data) considers the volume, variety, velocity of change, time, and location dependencies, while describing observation and measurement values. Another aspect that should be taken into consideration is how the data will be used and queried. Generally, queries of sensory data include attributes such as location (e.g., location tag, latitude, or longitude values), type (e.g., temperature, humidity, or light), time (e.g., timestamps, freshness of data), value (e.g., including observation and measurement value, value data-type, and unit of measurement), or other metadata (e.g., links to metadata, such as a links to descriptions that provide source or quality of information related attributes).

TABLE 1
Comparing IoT sensory data with conventional data content

| | | Conventional data |
|---|---|---|
| Attributes | IoT sensory data | content |
| Size | often very small (e.g., a few | usually much larger |
| | bytes); some IoT data can be a | than IoT data (e.g., |
| | real number and unit of measure- | video data of mega- |
| | ment; the metadata is usually | bytes or gigabytes) |
| | significantly larger than the | |
| | data itself | |
| Location | often device location dependent | normally not location |
| dependency | | dependent |
| Time | time dependent; may need to | normally not time |
| dependency | support various queries related | dependent |
| | to temporal attributes | |
| Life span | often short lived or transient | long lived |
| | (e.g., seconds, minutes, or | |
| | hours) | |
| Number | a sensor usually generates data | usually smaller than |
| | periodically, with a period to | IoT data items |
| | be seconds, minutes or hours, | |
| | so the number of data may be | |
| | large | |
| Persistency | some of the data needs to be | usually maintained |
| | maintained | |
| Resolution | names created from metadata for | resolution is usually |
| | resolution could be longer than | based on names |
| | conventional data (taking into | |
| | account temporal and spatial | |
| | dimensions) | |

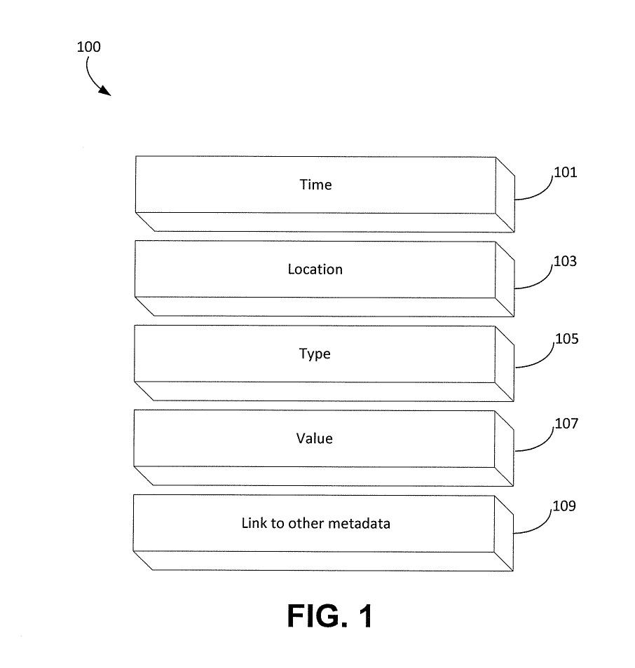

FIG. 1 illustrates a semantic description of a sensory data model 100 that follows a linked-data approach. In this model, the sensory data includes a time attribute 101, location attribute 103, type attribute 105, value attribute 107, and a link to other metadata 109. The sensory data may be linked to existing concepts that are defined in commonly used ontologies or vocabularies. And the detailed metadata and source related attributes may be provided as links to other sources. Model 100 provides a schema for describing such sensory data.

Geohash tagging, for example, may be used to describe the location attribute. Geohash is a mechanism that uses Base-N encoding and bit interleaving to create a string hash of the decimal latitude and longitude value of a geographical location. It uses a hierarchical structure and divides the physical space into grids. Geohashing is a symmetric technique that may be used for geotagging. A feature of geohashing is that nearby places will have similar prefixes in their string representation (with some exceptions). In an embodiment, a Geohashing algorithm is employed that uses Base32 encoding and bit interleaving to create a 12 byte hash string representation of latitude and longitude geo-coordinates. For example, the location of Guildford that has latitude value of “51.235401” and longitude value of “0.574600” is represented as “gcpe6zjeffgp.”

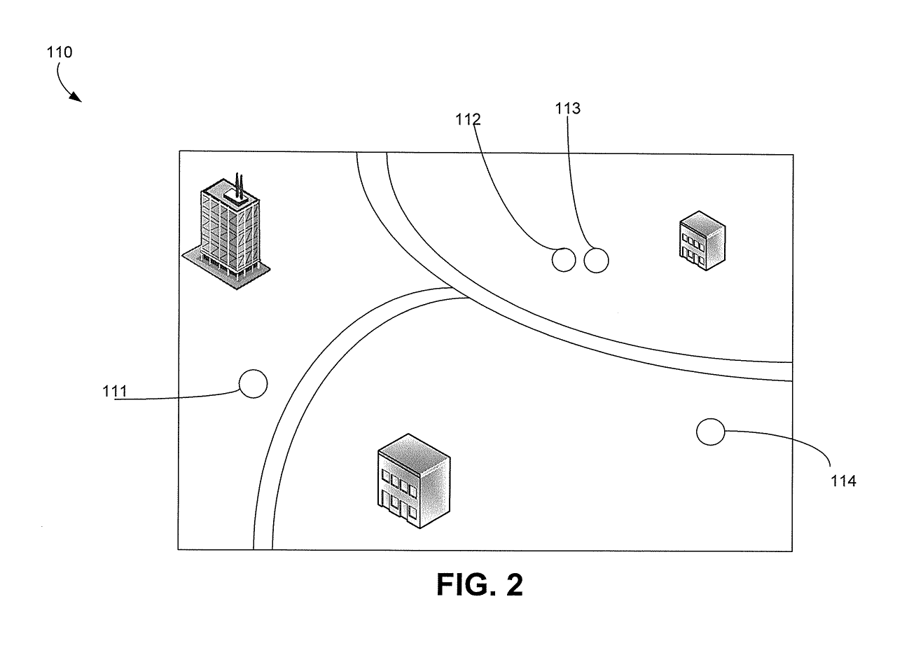

FIG. 2 shows four locations on a university campus marked on a map 110. Table 2 shows geohash location tags for the different locations on map 110. As can be observed in Table 2, the locations with close proximity have similar prefixes. The prefixes become more similar the closer the distance between locations. For example, position 111, position 112, position 113, and position 114 share the first six digits. Positions 112 and position 113 share the first eight digits (two additional digits compared to the other locations) because of their proximity. A geohash tag in a name of sensory data, with the use of a string similarity method, for example, may provide location based search in querying and discovering data. The location prefixes may be used to create an aggregated prefix when data is integrated or accumulated from different locations with close proximity. For example, the longest prefix string that is shared between all the sensory data may be used to represent an aggregated location prefix tag for the data.

TABLE 2
Geohash Location Tags

| Location | Geohash Location Tag |
|---|---|
| Position 111 | gcped86y1mzg |
| Position 112 | gcped8sfk80ka |
| Position 113 | gcped8sfq05ua |
| Position 114 | gcped87yp52m |

For the type attribute of the sensory data model, a concept may be adopted from NASA's semantic web for earth and environmental terminology (SWEET) ontology. SWEET consists of eight top-level concepts/ontologies: representation, process, phenomena, realm, state, matter, human activities, and quantity. Each has next-level concepts. All of them could be a value for the type attribute of the sensory data model. In various embodiments, the type attribute may be linked to existing concepts on a common vocabulary. In another embodiment, a more specific ontology for describing the type of sensory data may be employed.

As mentioned above, the attributes shown in FIG. 1 form a semantics model 100 for sensory data. Additional features, such as source related data (i.e., how the data is measured, use of a particular device, or quality of information), may be added in a modular form as they may be linked to information available on other sources such as the provider device itself, a gateway, etc. FIG. 1, shows the link to other metadata attribute 109. For example, a new semantic description module could be added to describe the quality of information attributes or measurement range properties, etc., and it could be linked to the core descriptions. The adding of additional features provides a flexible solution to describe streaming sensor data using embedded semantic naming where the model captures the core attributes of the data and the additional information may be provided as linked-data.

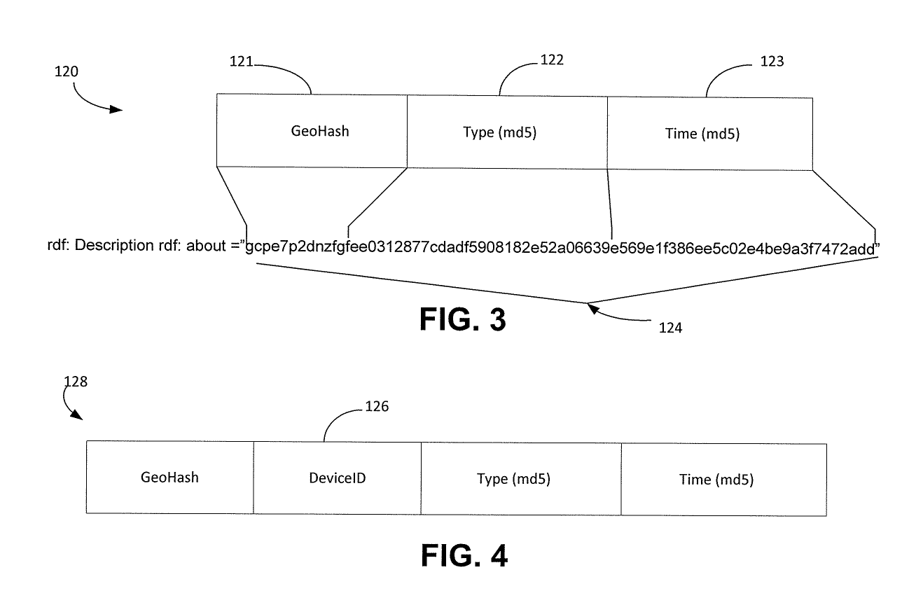

In accordance with an aspect of the present application, sensory data may be named using information including attributes of the semantic model 100 of FIG. 1, such as location, time (for a stream this may be starting time of the measurements in the current window of the stream), and type. As shown in FIG. 3, for example, a string may be created to represent an identification (ID) (i.e., embedded semantic name) 124 of sensory data. FIG. 3 illustrates an exemplary ID construction 120, in accordance with one embodiment. The ID construction 120 may comprise a location field 121 that comprises a geohash tag 121 of location information, a type field 122 that comprises a message digest algorithm five (MD5) of type information (e.g., temperature, humidity, or light), and a time field 123 that comprises a MD5 of time information. MD5 is a cryptographic hash function. The values in the location field 121, type field 122, and time field 123 may be put together to create ID 124 to be used as a name for the sensory data. In this example, ID 124 is used in the context of resource description framework (RDF). RDF is a framework for describing resources on the web.

Multiple sensors of the same type are often deployed in the same location to obtain duplicate sensory readings to achieve a level of reliability (e.g., device failures), consistency in measurement, or the like. The semantic model discussed herein addresses the issue of naming sensory data when multiple sensors of the same type are in the same location and provide sensory data at the same time. In an embodiment, the device identifier may be used with the embedded semantic naming of sensory data as shown in FIG. 4. FIG. 4 is similar to FIG. 3, but a DeviceID field 126 is added in ID construction 128. This field is used as the format for an embedded semantic name. The device identifier used in DeviceID field 126 may be a barcode or RFID tag, MAC address, a Mobile Subscriber ISDN Number (MSISDN), or the like. The length of DeviceID field 126 (or any other field) in FIG. 4 may be set to any number of bytes (e.g., 12 bytes) to accommodate the device identifiers. ID construction 120 and ID construction 128 are ways to create an embedded semantic name for sensory data that reflects the attributes discussed herein.

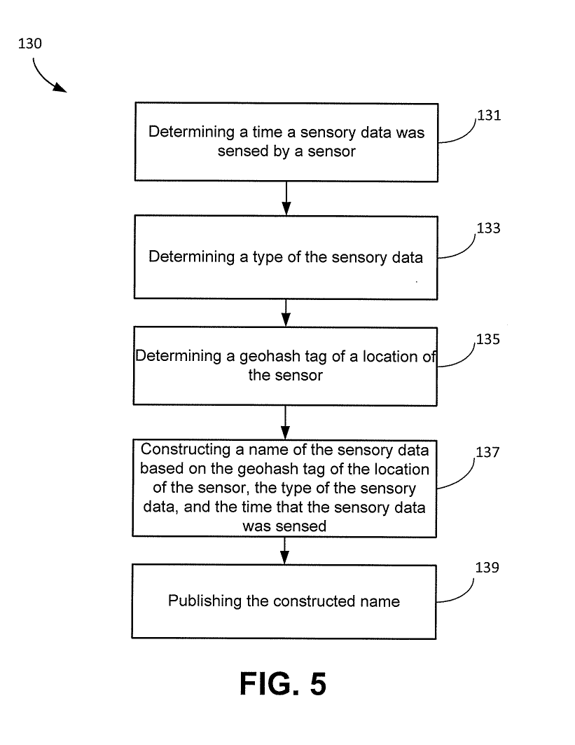

FIG. 5 illustrates an exemplary method 130 for embedded semantic naming of sensory data. At step 131, a time a sensory data was sensed by a sensor is determined. At step 133, a type of the sensory data is determined. A type depends on the source of the sensory data. For example, data that originated from a sensor that senses temperature may have a temperature type or data that originated from a sensor that senses humidity may have a humidity type. At step 135, a geohash tag of a location of the sensor that produced the sensory data is determined. At step 137, an embedded semantic name of the sensory data is constructed based on the type of the sensory data, the geohash tag of the location of the sensor, and the time that the sensory data was sensed. For example, the embedded semantic name may be constructed in accordance with the example construction as discussed with regard to FIG. 3. As further illustrated in FIG. 4, in another embodiment, the embedded semantic name may also include a device identifier of the sensor, along with the type of the sensory data, the geohash tag of the location of the sensor, and the time that the sensory data was sensed. In an embodiment, the name of sensory data may be generated by its source (e.g., sensor). At block 139, the constructed name may be published to other computing devices. For example, the sensor may provide the embedded semantic names to a gateway along with the associated sensory data or separate from the associated sensory data. In an embodiment, name creation may be done by a gateway or by a specialized naming server.

With regard to method 130, for resource constrained devices, constructing the name of the sensory data by the sensor may consume a relatively significant amount of power and other resources. In addition, if the sensor publishes the name of sensory data to a gateway, the publishing may consume a significant amount of network bandwidth and impose significant overhead to intermediate nodes in forwarding the name. This especially may be an issue when the intermediate node is also a resource-constrained device. In some embodiments, an intermediate node may be a relay node which forwards the sensory data from an originator to a gateway. For example, in sensor networks, the intermediate node may be a sensor between the originating sensor and the gateway.

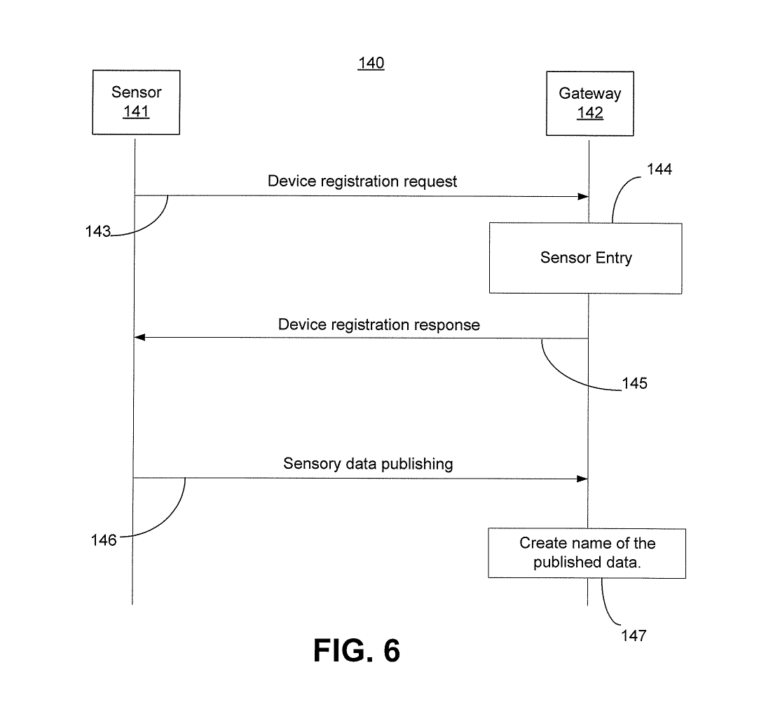

FIG. 6 illustrates an exemplary flow 140 for naming of sensory data and publishing the data. At step 143, a device registration request may be sent from sensor 141 to gateway 142. In the registration request, sensor 141 may inform the gateway 142 of its location, device identifier, and its supported type(s), for example. The location may be in the form of a geohash, a longitude and latitude, a civic location, a specific physical address, or the like. If the location information is not in the form of a geohash, gateway 142 may be responsible for converting the received location to the format of a geohash tag (or another desired location format). Sensor 141 may move from one location to another location, and may re-register with gateway 142 to indicate a location change. The registration of a location change by sensor 141 may happen at a set time, at a set period (e.g., at time intervals of 10 seconds), or when a particular predetermined location is reached, which may be preferred for devices that change locations often. The type of sensing that the sensor 141 performs may also be included in the registration request at step 143, which may be stored in the MD5 format by gateway 142. Sensor 141 may support more than one type of sensing (e.g., temperature and humidity). Gateway 142 may assign a label to each type of sensing performed by sensor 141 (e.g., temperature has label of 1, while humidity has label of 2).

At step 144, gateway 142 builds an entry to store the stream of sensory data that will be received from sensor 141. Table 3 shows an example of some sensor information that may be received and stored in the sensor entry built by the gateway at step 144. As shown, in this example, the sensor information may include the device identifier of the sensor, location of the sensor, and type of sensing the sensor supports, among other things. At step 145, gateway 142 sends a message in response to the device registration to sensor 141, which includes the labels of the types, if there is more than one type supported by sensor 141. The type label (e.g., 1 or 2 in Table 3) shows the type of the published data. The corresponding MD5 of the type is retrieved from the device information. At step 146, sensor 141 publishes sensory data to gateway 142, which may include the sensory data value (e.g. temperature), the time when the sensory data is sensed (e.g., noon), the location of the sensor (e.g., longitude and latitude), the device identifier of the sensor (e.g., MAC address), and the type label (e.g., 1). At step 147, gateway 142 is able to generate an embedded semantic name for the published data, in accordance with the example naming techniques/constructions and sensory data model illustrated in FIG. 1, FIG. 3, and FIG. 4 and described above.

TABLE 3
Sensor Device Information Entry

| Device Identifier | Location | Type |
|---|---|---|
| DeviceID | Geohash | MD5 of temperature type (label = 1) |
| | | MD5 of humidity (label = 2) |

As discussed, with the sensory data model and naming procedures disclosed herein, the semantics of a sensory data may be incorporated in its name, such as location, source, type, and time. Therefore, when a gateway publishes the name of the sensory data to other entities (e.g., another gateway or server), the semantics of the data embedded in the name do not need to be retrieved from the original data publisher (e.g., gateway 142).

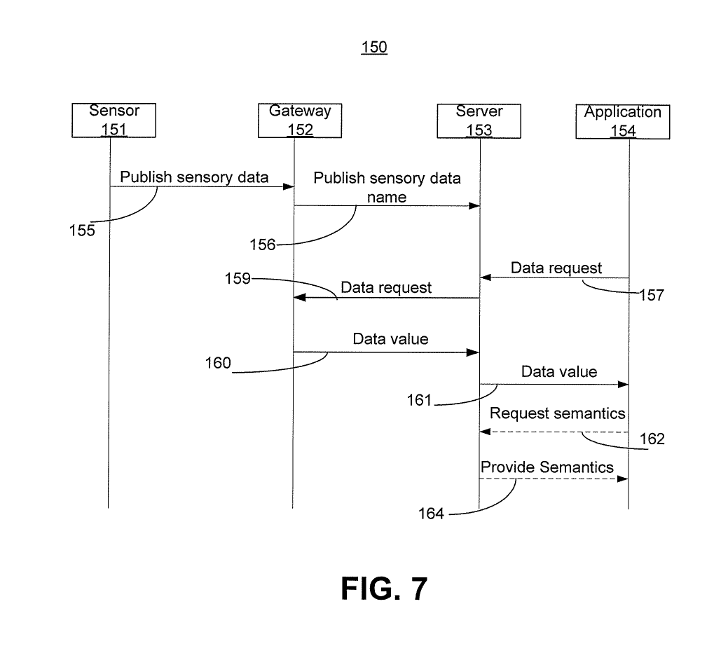

FIG. 7 illustrates a sensory data query flow, in which an application 154 retrieves sensory data, and then receives related semantics. At step 155, sensor 151 publishes a sensory data (e.g., as discussed herein with regard to FIG. 6). At step 156, gateway 152 sends the embedded semantics name of the sensory data to server 153. At step 157, application 154 sends to server 153 a message to request data. At step 159, server 153 forwards the request to gateway 152 to retrieve the value of the sensory data sensed by sensor 151. At step 160, gateway 152 provides the value of the sensory data to server 153, which forwards the value of the sensory data to application 154. If the sensory data received at 161 has embedded semantics naming that corresponds with the attributes application 154 desires then no further semantics information is needed. But if application 154 needs further information not provided by embedded semantics naming in order to understand and use the sensory data, application 154 may request the semantics of the sensory data. At optional step 162, application 154 requests the semantics of the requested sensory data (e.g., location, type, time, and source). At step 164, server 153 forwards the semantics for the sensory data. Based on the implementation, an application may retrieve the semantics information from server 153, gateway 152, sensor 151, or another device. As discussed herein, the semantics information may assist an application with regard to how to interpret data of different formats.

In accordance with another aspect of the present application, the disclosed naming scheme with embedded semantics for sensory data facilitate data aggregation. In particular, data aggregation can be performed automatically by using the fields (e.g., location of sensor, type, or time) in the name created for a sensory data the manner described above, without any additional information to instruct how to perform the aggregation. The aggregation may happen at the data producer (e.g., sensors), intermediate nodes with the same geohash location between the data producer and a data collector, and at the data collector (e.g., gateway). The attributes of a sensor (e.g., location, device identifier, and supported types) may not change frequently. The data aggregation at the sensor may be done over a significant period (e.g., minutes, hours, days, or months), which means the sensor may not need to publish the sensory data each time it senses. The sensor may aggregate the data sensed over a period (e.g., the average of all the sensory data in a period of 30 minutes). In this case, the time attribute embedded in the semantic name for the aggregated data may be the period of the aggregated data.

The disclosed naming scheme with embedded semantics for sensory data may also be used to facilitate the clustering of sensory data. Clustering mechanisms, such as K-Means (a method of vector quantization), may be used to cluster the sensory data into different repositories. The use of a prediction method based on a clustering model may allow for identification of the repositories that maintain each part of the data. For example, each repository may maintain one type of clustering of the sensory data, such as location, device, type, or time.

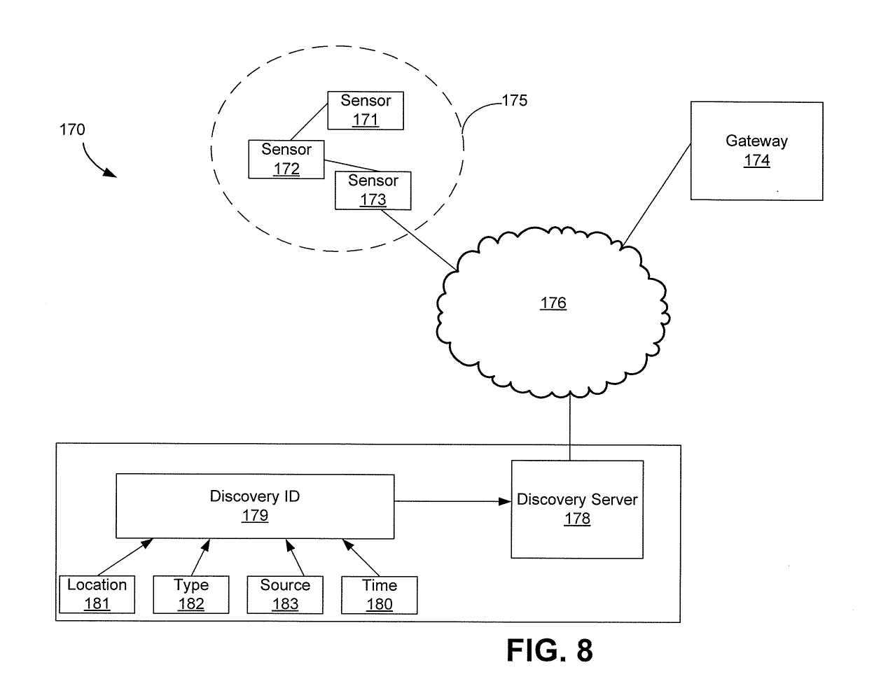

To further illustrate the concept of how the disclosed semantic naming scheme can be used to facilitate data aggregation, as well as to illustrate how discovery and querying of stored sensory data can be performed, FIG. 8 provides a block diagram of one embodiment of a system 170 that implements the semantic model for naming sensory data described herein. In FIG. 8, location 175 contains a plurality of communicatively connected sensors that include sensor 171, sensor 172, and sensor 173. Sensor 172 and sensor 173 are intermediate nodes between sensor 171 and gateway 174. Gateway 174 is communicatively connected to area 175 and discovery server 178 via network 176.

Gateway 174 (or another computing device), as the collector of the sensory data from sensor 171, sensor 172, and sensor 173, may aggregate the sensory data and consolidate the semantic name for the aggregated data over different fields (e.g., location, device identifier, type, or the like) in the names. Gateway 174 or another computing device may predefine rules or policies for aggregating sensory data. For example, gateway 172 may have a policy to average sensor readings in Manhattan, Brooklyn, and Queens. The average sensory readings for Manhattan, Brooklyn, and Queens may have a location identifier of “New York City” or a single representative geohash that has the first few common letters (e.g., “gpced”) of several sensor geohashes. In another example, readings for October, November, and December, may be averaged and have a single representative time identifier of winter.

In an embodiment, sensor 171, sensor 172, and sensor 173 may support a temperature type. Sensor 171 may initiate publishing of sensory data with semantic naming to gateway 174 at a particular time “t1.” Sensor 172 has the same geohash location as sensor 171 (and is an intermediate node between sensor 171 (e.g., the initial data producer) and gateway 174 (e.g., the data collector). Sensor 172 may aggregate received sensory data with sensed sensory data (sensed by sensor 172 at or near time t1) for devices located at location 175. This aggregation of sensory data may be triggered when sensor 172 receives sensory data from the previous hop (e.g., sensor 171) destined for gateway 174. The aggregated sensory data may be assigned the same device identifier (e.g., identifier used in DeviceID field 126) in the semantic name as the originally published sensory data published by sensor 171. In another example, the device identifier may be reflective of just the last sensor (intermediate node) that did sensory data aggregation or forwarded the sensory data. In another example, the device identifier may be reflective of a combination of the identifiers of sensors that participated in sensory data aggregation or forwarded the sensory data. In yet another example, multiple sensory data from different sensors may be treated as one data with one unique naming, because the multiple sensory data from different sensors may have the same value, similar value, an averaged value, or the like.

Referencing again FIG. 8, gateway 174 may publish aggregated sensory data along with original sensory data to discovery server 178, which has discovery functionalities. The aggregated data may be generated and stored in gateway 174 as low-level context information that may be queried by applications and used to derive high-level context information. Queries for sensory data may combine information from several attributes and also from several sources. The possible types of queries from streams of sensory data may be identified as exact queries, proximate queries, range queries, or composite queries. Exact queries involve requesting known data attributes, such as type, location, or time attributes. Other metadata attributes such as quality of information (QoI) or unit of measurement may also be included in exact queries. Proximate queries involve requesting data from an approximate location or with a threshold of quality of information. Range queries involve requesting a time range or location range used to query data. A composite query is a query that uses another query as its data source. Composite queries may involve the result of the query being provided by integration (and processing) of data from different sources and sometimes with different types. The rules or policies on how to integrate or aggregate data may be provided along with the composite queries. For example, data may be queried based on a location of CityX with type temperature and humidity, which is sensed during the weekend of March 1st and 2nd.

The embedded semantics naming scheme disclosed herein enables these kinds of queries to be made and processed. Queries may be mapped to one of the fields in the embedded semantics name of the sensory data. In an example, for range queries, responses to the time or location range based queries may be reflective of discovery server 178 directly mapping the queries to the time and location fields in the sensory data name. In another example, for composite queries, responses to the source and type based queries may be reflective of discovery server 178 directly applying reverse rules/policies and mapping them to the location, type, time, and source fields in the sensory data name. In another example, for proximate queries, a query may use an initial prefix of a geohash in a sensory data name in order to approximate location. The response to the proximate query may be based on a mapping of the prefix of the geohash to the geohash field.

As shown in FIG. 8, time 180, location 181, type 182, or source 183 (e.g., device identifier) may be input to create a discovery identifier (discovery ID) 179 of a query that is processed by discovery server 178. In this embodiment, sensory data may be found by inputing a discovery ID 179 that is compared to semantic names. In essence, the discovery ID 179 is the query in that it reflects the parameters of the query (e.g., time, location, type, or source). Discovery server 178 may be a standalone computing device or a logical entity that resides within gateway 174 or another server. For exact queries, discovery ID 179 may be time 180, location 181, type 182, or source 183. For proximate queries, discovery ID 179 may be some prefix of the geohash. For range queries, discovery ID 179 may be composed of a location range or a time range. For composite queries, discovery ID 179 may be composed of time 180, location 181, type 182, or source 183 with designated policies.

The disclosed procedures for embedded semantic name publishing, aggregating, and querying of sensory data may be bound to one or more existing protocols, such as hypertext transfer protocol (HTTP) or constrained application protocol (CoAP), among others. To do so, protocols such as HTTP or CoAP may be used as an underlying transport protocol for carrying the requests and responses. The requests and responses may be encapsulated within the payload of HTTP/CoAP messages or alternatively some information within the requests and responses may be bound to fields within the HTTP/CoAP headers and/or options. In an embodiment, embedded semantic name publishing, data aggregation, and data query requests and response protocol primitives may be encoded as JavaScript object notation (JSON) or extensible markup language (XML) descriptions that are carried in the payload of HTTP or CoAP requests and responses. Embodiments disclosed herein may also involve advanced message queuing protocol (AMQP) or message queue telemetry transport (MQTT).

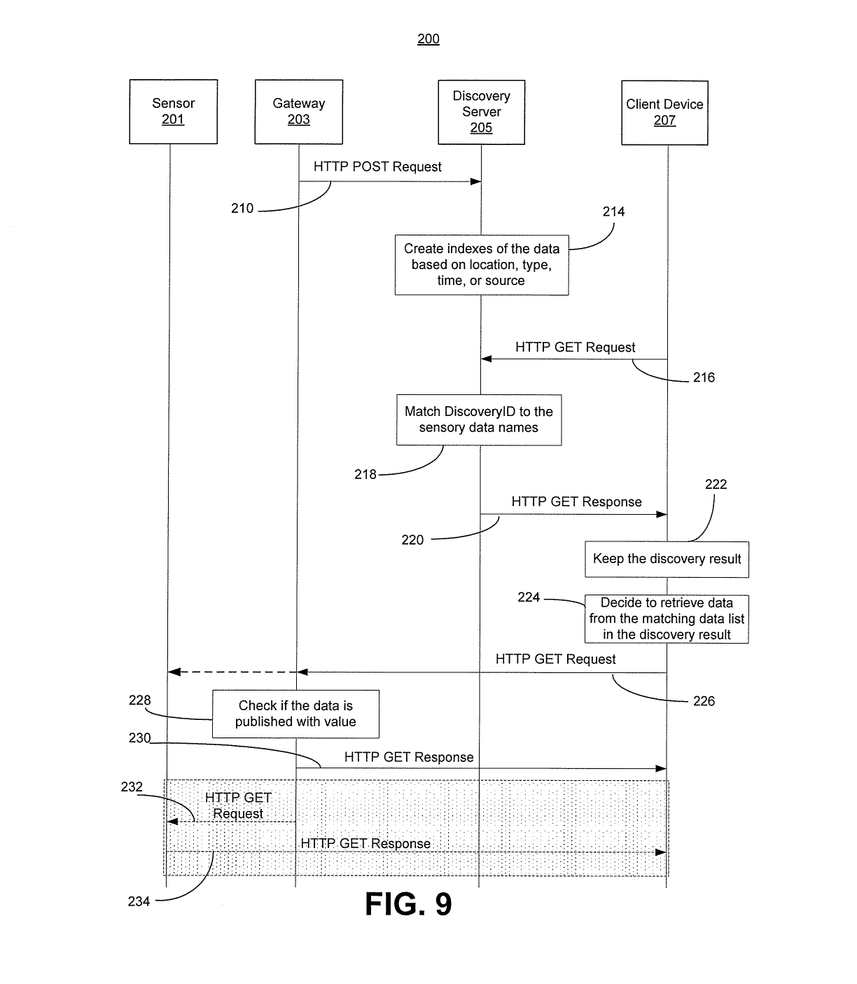

FIG. 9 illustrates one example of a sensory data query flow 200, in accordance with the techniques and mechanisms disclosed above. The flow 200 of FIG. 9 illustrates a data query in which the requests and responses are carried in accordance with the HTTP protocol. Referring to FIG. 9, gateway 203 collects data sensed by sensors, such as sensor 201. At step 210, gateway 203 sends a HTTP POST request message to discovery server 205. The HTTP POST request message at step 210 includes a payload of sensory data to which the semantic naming scheme described herein has been applied. POST is a method supported by the HTTP protocol and is designed to request that a web server accept the data enclosed in the body of the request message for storage.

At step 214, discovery server 205 may create indexes of any received sensory data based on the attributes of location, type, time, or source, for example, retrieves from the semantic name of each item of sensory data—which facilitates discovery and querying of the sensory data. The sensory data received by discovery server 205 may be published original sensory data and/or published aggregated data from the gateway 203, as described herein. Discovery server 205 may further aggregate data based on a prediction from past query requests or results. At step 216, an HTTP GET request message may be sent by client device 207 (e.g., user equipment) to discovery server 205. GET is a method supported by the HTTP protocol and is designed to request data from a specified resource. The HTTP GET request message sent at step 216 may comprise a discovery request with a discovery ID composed of location, type, time, or source parameters. At step 218, discovery server 205 matches the discovery ID received in step 216 to the sensory data by comparing the fields in the discovery ID with the fields of the embedded semantic names of the stored sensory data. Discovery server 205 looks at the specific fields (bytes) in the sensory data semantic name fields. The discovery server 205 may not need additional semantics information of the sensory data if a query matches the existing fields. The overhead (e.g., processing needed) of discovery server 205 in finding matching sensory data may be significantly less because of the embedded semantic naming. At step 220, an HTTP GET response message is sent to requesting client device 207. The payload of the HTTP GET response message has the matching sensory data names, which correspond to the request at step 216.

At step 222, client device 207 stores the discovery result of the sensory data name for future usage. At step 224, client device 207 may decide to retrieve data that matches a stored sensory data name. At step 226, an HTTP GET request message may be sent to sensor 201 or gateway 203 with a payload that includes the name of the sensory data the client device wishes to retrieve. In either case, at step 228, gateway 203 may determine if the requested sensory data is stored on gateway 203. The HTTP GET request sent at step 226 may be intercepted by gateway 203 and gateway 203 may check to determine if sensor 201 has published the matching data value instead of just the embedded semantic name. If gateway 203 has matching data values, gateway 203, at step 230, may reply with a HTTP GET response message that includes the appropriate sensory data values. Gateway 203 may keep a cached copy of the requested sensory data values, if the requested sensory data was retrieved before by other clients. In an embodiment, when gateway 203 does not have a copy of the published data value, at step 232, gateway 203 may forward the HTTP GET request sent at step 226 to sensor 201. At step 234, sensor 201 may respond with a HTTP GET response sent to respond to the HTTP GET request originally sent at step 226.

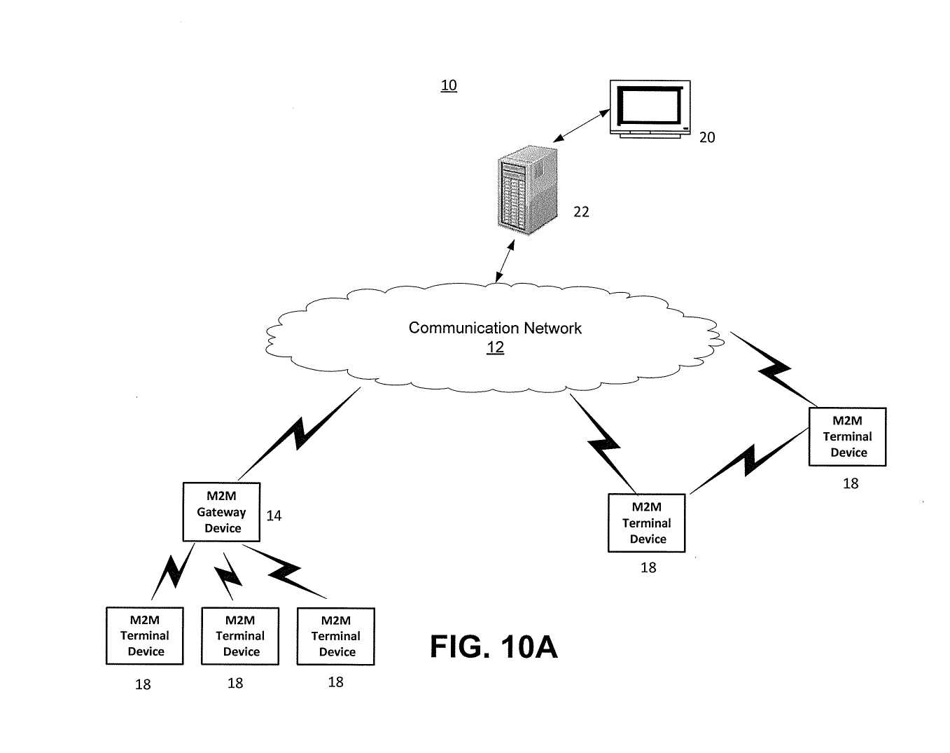

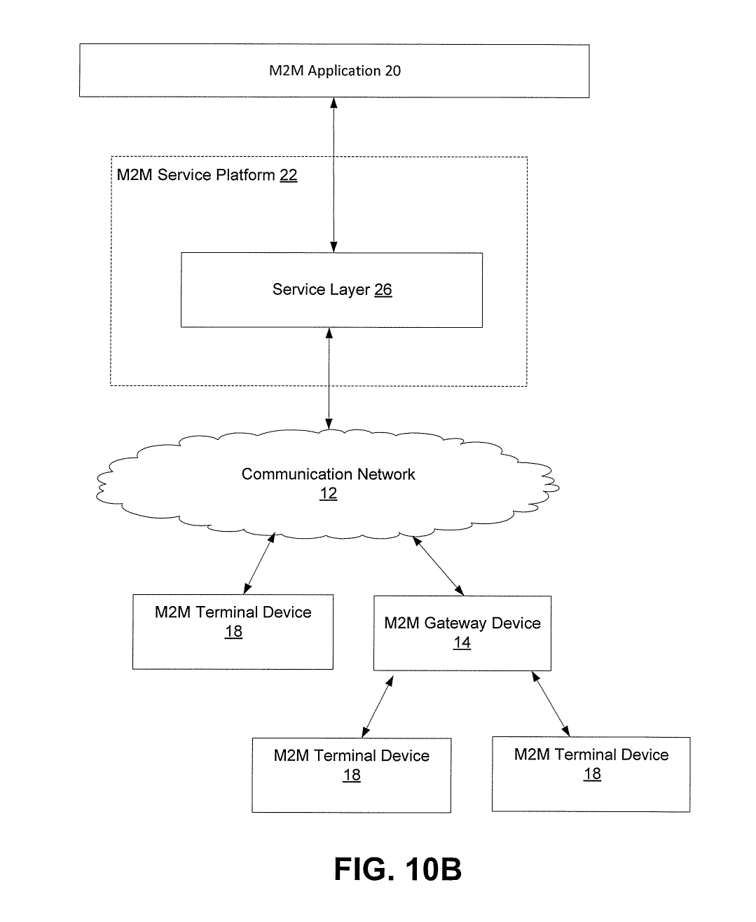

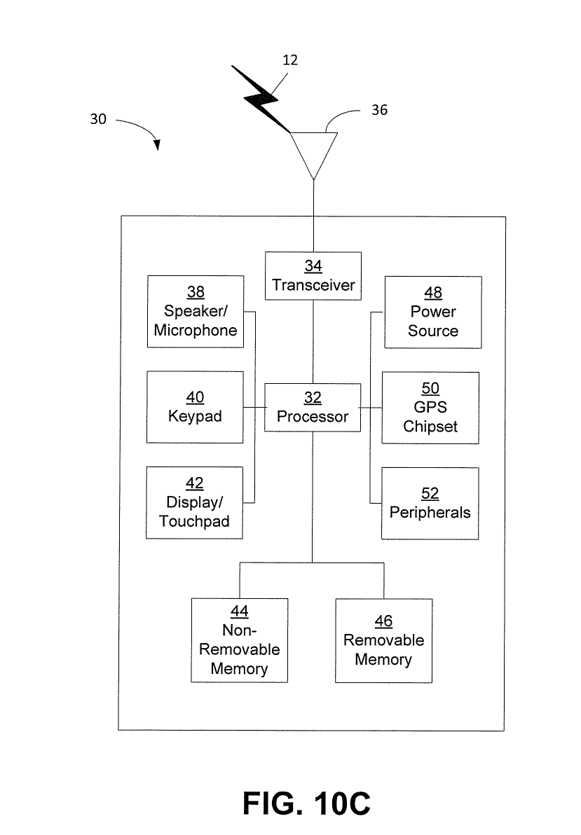

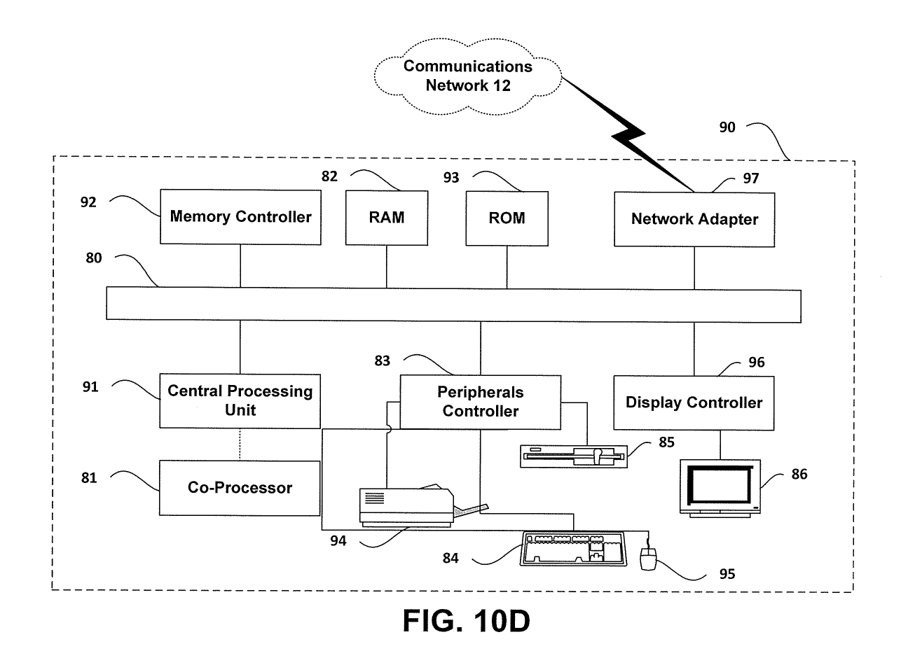

FIG. 10A is a diagram of an example machine-to machine (M2M) or Internet of Things (IoT) communication system 10 in which one or more disclosed embodiments may be implemented. Generally, M2M technologies provide building blocks for the IoT, and any M2M device, gateway or service platform may be a component of the IoT as well as an IoT service layer, etc.

As shown in FIG. 10A, the M2M/IoT communication system 10 includes a communication network 12. The communication network 12 may be a fixed network or a wireless network (e.g., WLAN, cellular, or the like) or a network of heterogeneous networks. For example, the communication network 12 may comprise of multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 10A, the M2M/IoT communication system 10 may include an M2M gateway device 14, and M2M terminal devices 18. It will be appreciated that any number of M2M gateway devices 14 and M2M terminal devices 18 may be included in the M2M/IoT communication system 10 as desired. Each of the M2M gateway devices 14 and M2M terminal devices 18 are configured to transmit and receive signals via the communication network 12 or direct radio link. The M2M gateway device 14 allows wireless M2M devices (e.g. cellular and non-cellular) as well as fixed network M2M devices (e.g. PLC) to communicate either through operator networks, such as the communication network 12 or direct radio link. For example, the M2M devices 18 may collect data and send the data, via the communication network 12 or direct radio link, to an M2M application 20 or M2M devices 18. The M2M devices 18 may also receive data from the M2M application 20 or an M2M device 18. Further, data and signals may be sent to and received from the M2M application 20 via an M2M service platform 22, as described below. M2M devices 18 and gateways 14 may communicate via various networks including, cellular, WLAN, WPAN (e.g., Zigbee, 6LoWPAN, Bluetooth), direct radio link, and wireline for example.

The illustrated M2M service platform 22 provides services for the M2M application 20, M2M gateway devices 14, M2M terminal devices 18 and the communication network 12. It will be understood that the M2M service platform 22 may communicate with any number of M2M applications, M2M gateway devices 14, M2M terminal devices 18 and communication networks 12 as desired. The M2M service platform 22 may be implemented by one or more servers, computers, or the like. The M2M service platform 22 provides services such as management and monitoring of M2M terminal devices 18 and M2M gateway devices 14. The M2M service platform 22 may also collect data and convert the data such that it is compatible with different types of M2M applications 20. The functions of the M2M service platform 22 may be implemented in a variety of ways, for example as a web server, in the cellular core network, in the cloud, etc.

Referring also to FIG. 10B, the M2M service platform typically implements a service layer 26 (e.g. a network service capability layer (NSCL)) that provides a core set of service delivery capabilities that diverse applications and verticals can leverage. These service capabilities enable M2M applications 20 to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layer 26 also enables M2M applications 20 to communicate through various networks 12 in connection with the services that the service layer 26 provides.

In some embodiments, M2M applications 20 may include desired applications that communicate retrieving sensory data with embedded semantic naming, as discussed herein. M2M applications 20 may include applications in various industries such as, without limitation, transportation, health and wellness, connected home, energy management, asset tracking, and security and surveillance. As mentioned above, the M2M service layer, running across the devices, gateways, and other servers of the system, supports functions such as, for example, data collection, device management, security, billing, location tracking/geofencing, device/service discovery, and legacy systems integration, and provides these functions as services to the M2M applications 20.

FIG. 10C is a system diagram of an example M2M device 30, such as an M2M terminal device 18 or an M2M gateway device 14 for example. As shown in FIG. 10C, the M2M device 30 may include a processor 32, a transceiver 34, a transmit/receive element 36, a speaker/microphone 38, a keypad 40, a display/touchpad 42, non-removable memory 44, removable memory 46, a power source 48, a global positioning system (GPS) chipset 50, and other peripherals 52. It will be appreciated that the M2M device 40 may include any sub-combination of the foregoing elements while remaining consistent with an embodiment. This device may be a device that uses the disclosed systems and methods for embedded semantics naming of sensory data.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, and/or any other functionality that enables the M2M device 30 to operate in a wireless environment. The processor 32 may be coupled to the transceiver 34, which may be coupled to the transmit/receive element 36. While FIG. 10C depicts the processor 32 and the transceiver 34 as separate components, it will be appreciated that the processor 32 and the transceiver 34 may be integrated together in an electronic package or chip. The processor 32 may perform application-layer programs (e.g., browsers) and/or radio access-layer (RAN) programs and/or communications. The processor 32 may perform security operations such as authentication, security key agreement, and/or cryptographic operations, such as at the access-layer and/or application layer for example.

The transmit/receive element 36 may be configured to transmit signals to, or receive signals from, an M2M service platform 22. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 10C as a single element, the M2M device 30 may include any number of transmit/receive elements 36. More specifically, the M2M device 30 may employ MIMO technology. Thus, in an embodiment, the M2M device 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the M2M device 30 may have multi-mode capabilities. Thus, the transceiver 34 may include multiple transceivers for enabling the M2M device 30 to communicate via multiple RATs, such as UTRA and IEEE 802.11, for example.

The processor 32 may access information from, and store data in, any type of suitable memory, such as the non-removable memory 44 and/or the removable memory 46. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the M2M device 30, such as on a server or a home computer. The processor 32 may be configured to control lighting patterns, images, text, or colors on the display or indicators 42 in response to embedded semantic naming of sensory data. For example, whether some embodiments described herein are successful or unsuccessful, or otherwise indicate the status of process steps involving embedded semantic naming.

The processor 32 may receive power from the power source 48, and may be configured to distribute and/or control the power to the other components in the M2M device 30. The power source 48 may be any suitable device for powering the M2M device 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the M2M device 30. It will be appreciated that the M2M device 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include an accelerometer, an e-compass, a satellite transceiver, a sensor, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 10D is a block diagram of an exemplary computing system 90 on which, for example, the M2M service platform 22 of FIG. 10A and FIG. 10B may be implemented. Computing system 90 may comprise a computer or server and may be controlled primarily by computer readable instructions, which may be in the form of software, wherever, or by whatever means such software is stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91. CPU 91 and/or coprocessor 81 may receive, generate, and process data related to the disclosed systems and methods for embedded semantic naming, such as queries for sensory data with embedded semantic names.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86. Display 86, may display sensory data in files or folders using embedded semantics names. For example, the names of the folders in a format shown in FIG. 3, FIG. 4, or the like.

Further, computing system 90 may contain network adaptor 97 that may be used to connect computing system 90 to an external communications network, such as network 12 of FIG. 10A and FIG. 10B.

It is understood that any or all of the systems, methods and processes described herein may be embodied in the form of computer executable instructions (i.e., program code) stored on a computer-readable storage medium which instructions, when executed by a machine, such as a computer, server, M2M terminal device, M2M gateway device, or the like, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other physical medium which can be used to store the desired information and which can be accessed by a computer.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. For example, although embedded semantic naming for sensory data is disclosed the methods systems herein may be used with any data.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A device comprising:
a processor; and
a memory coupled with the processor, the memory comprising executable instructions that when executed by the processor cause the processor to effectuate operations comprising:
receiving a first sensory data with first attributes comprising a first time attribute, a first location attribute, and a first type attribute; and
creating a first name for the sensory data based on the first time attribute, the first location attribute, and the first type attribute.

2. The device of claim 1, wherein the executable instructions cause the processor to effectuate further operations comprising:
publishing the first name to a server, wherein the server stores the first name to enable queries to be made on the sensory data based on the first time attribute, the first location attribute, or the first type attribute.

3. The device of claim 1, wherein the executable instructions cause the processor to effectuate further operations comprising:
aggregating the first sensory data with a second sensory data, the second sensory data having second attributes comprising a second time attribute, a second location attribute, or a second type attribute; and
assigning the first name to the aggregated first sensory data and second sensory data.

4. The device of claim 1, wherein the executable instructions cause the processor to effectuate further operations comprising:
providing instructions to display the first name on a display.

5. The device of claim 1, wherein the first location attribute comprises a geohash tag.

6. The device of claim 1, wherein the first name comprises a message digest of the first type.

7. The device of claim 1, wherein the first name comprises a message digest of the first time attribute.

8. The device of claim 1, wherein the device comprises a sensor.

9. The device of claim 1, wherein the first name comprises a device identifier of the device.

10. A computer readable storage medium comprising computer executable instructions that when executed by a computing device cause said computing device to perform the instructions comprising:
receiving a first sensory data with first attributes comprising a first time attribute, a first location attribute, and a first type attribute; and
creating a first name for the sensory data based on the first time attribute, the first location attribute, and the first type attribute.

11. The computer readable storage medium of claim 10, further instructions comprising:
publishing the first name to a server, wherein the server stores the first name to enable queries to be made on the sensory data based on the first time attribute, the first location attribute, or the first type attribute.

12. The computer readable storage medium of claim 10, further instructions comprising:
aggregating the first sensory data with a second sensory data, the second sensory data having second attributes comprising a second time attribute, a second location attribute, or a second type attribute; and
assigning the first name to the aggregated first sensory data and second sensory data.

13. The computer readable storage medium of claim 10, further instructions comprising:
providing instructions to display the first name.

14. The computer readable storage medium of claim 10, wherein the first location attribute comprises a geohash tag.

15. The computer readable storage medium of claim 10, wherein the first name comprises the message digest of the first type attribute.

16. The computer readable storage medium of claim 10, wherein the first name comprises the message digest of the first time attribute.

17. The computer readable storage medium of claim 10, wherein the computing device comprises a sensor.

18. The computer readable storage medium of claim 10, wherein the first name comprises a device identifier of the computing device.

19. A method comprising:
observing, by a sensor, a sensory data with a value, wherein the sensory data with the value has attributes comprising a time attribute, a location attribute, and a type attribute;
creating, by the sensor, a name for the sensory data based on the time attribute, the location attribute, and the value attribute; and
publishing, by the sensor, the name to a server.

20. The method of claim 19, wherein the server receives queries for the sensory data, the queries comprising the time attribute, the location attribute, the value attribute, or a type attribute.
